(19) United States
(12) Patent Application Publication
(10) Pub. No.: US 2025/0377234 A1
(43) Pub. Date: Dec. 11, 2025

(54) METHOD FOR DETERMINING THE FLUID FILL LEVEL IN A TANK FOR HOLDING FLUIDS, AND TANK FOR HOLDING FLUIDS

(71) Applicant: HELLA GmbH & Co. KGaA, Lippstadt (DE)

(72) Inventor: Thomas NIEMANN, Delmenhorst (DE)

(21) Appl. No.: 19/231,039

(22) Filed: Jun. 6, 2025

(30) Foreign Application Priority Data
Jun. 6, 2024 (DE) 102024115873.5
May 19, 2025 (DE) 102025119294.4

(51) Int. Cl. G01F 23/296; B60K 15/03; G01F 23/80

(52) U.S. Cl. CPC G01F 23/2966; B60K 15/03; G01F 23/2968; G01F 23/80; B60K 2015/03217

(57) ABSTRACT

A method is provided for determining the fluid fill level in a tank for holding fluids. The tank is connected to at least one sensor assembly in a manner conductive of structure-borne sound signals. The sensor assembly includes at least one structure-borne sound sensor for capturing structure-borne sound signals propagating in and on the tank. Structure-borne sound signals propagating in and on the tank are captured by means of the structure-borne sound sensor, and a conclusion is drawn about the fluid fill level in the tank on the basis of the captured structure-borne sound signals. The invention further relates to a tank for holding fluids and a motor vehicle with a tank according to the invention.

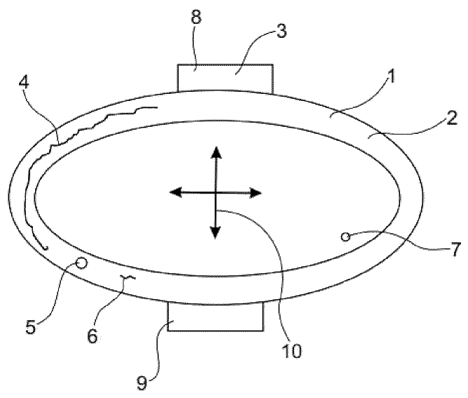

### FIELD OF THE INVENTION

The invention relates to a method for determining the fluid fill level in a tank for holding fluids and to a tank for holding fluids.

### BACKGROUD OF THE INVENTION

A tank may be a tank for a motor vehicle. In particular, such a tank may be a tank for liquid gas such as hydrogen, but it may also be a tank for holding fuels such as petrol or diesel or the like. A tank for holding hydrogen may for example include an outer casing made from a fibre-reinforced plastic, for example from glass fibre-reinforced plastic or carbon fibre-reinforced plastic. The tank may further include an inner, gas-permeable casing, made from PTFE for example, in which the fluid is received. Difficulties can arise in particular when determining the fluid fill level in vehicle liquid gas fuel tanks of such kind.

A liquid level measurement assembly for a vehicle liquid gas fuel tank is known for example from DE 102 58 235 A1. In this case, a strain gauge mounted on a bearing of the vehicle and at least one pressure measurement sensor mounted outside the vehicle tank and linked to the vehicle tank via a line are provided. The strain gauge and the pressure measurement sensor are each connected to an onboard computer via a line.

The problem addressed by the invention is that of suggesting a method for determining the fluid fill level in a tank, and a tank, with which a determination of a fluid fill level can be determined simply.

This problem is solved with a method having the features of the claims and with a tank having the features of the claims. Refinements and variants are specified in the subordinate claims.

### SUMMARY

A method for determining the fluid fill level in a tank for holding fluids, wherein the tank is connected to at least one sensor assembly in a manner conductive of structure-borne sound signals, wherein the sensor assembly includes at least one structure-borne sound sensor for detecting structure-borne sound signals propagating in and on the tank, wherein structure-borne sound signals propagating in and on the tank are detected by means of the structure-borne sound sensor, and wherein a conclusion is drawn about the fluid fill level in the tank on the basis of the detected structure-borne sound signals is provided as essential to the invention. The tank may be in particular a hydrogen tank of a motor vehicle, wherein the tank may include at least an outer casing. A gas-impermeable inner casing may be surrounded by the outer casing. In this context, the outer casing of the tank may be manufactured from a fibre-reinforced composite material, in particular from glass fibre-reinforced plastic or carbon fibre-reinforced plastic. When the tank is filled with a fluid medium, in particular with hydrogen, the tank and therewith the inner casing and also the outer casing thereof may expand, thus causing the outer casing to vibrate. These vibrations can be captured in the form of structure-borne sound signals. In order to enable structure-borne sound signals to be captured, the tank is connected in a manner conductive of structure-borne sound signals with at least one structure-borne sound sensor of a sensor assembly. The sensor assembly preferably includes a plurality of structure-borne sound sensors. In order to capture the vibrations, the structure-borne sound sensor may contain a piezoelectric element for example. The vibrations that are created when the tank is filled or emptied are captured by means of the sensor assembly. The vibrations created are characteristic of the respective fluid fill level in the tank, and the vibrations propagating in and on the tank can change depending on the fluid fill level. Accordingly, the vibrations propagating in and on the tank can be associated with a fluid fill level in each case. In such case, characteristic structure-borne sound signals may be emitted for different fill statuses and are captured and evaluated. A conclusion may be drawn about the respective fluid fill level in the tank from the evaluated structure-borne sound signals. In order to evaluate the structure-borne sound signals, the sensor assembly has a connection that allows data to be transmitted to an evaluation device. The evaluation device may be for example a computing unit, the onboard computer or similar.

In a further development of the method, at least one structure-borne sound signal propagating in and on the tank is captured for at least one known fluid fill level and stored as reference value. Different characteristic structure-borne sound signal patterns can be produced for different fluid fill levels of the tank, that is to say for different fluid volumes held in the tank. For example, during a filling operation the structure-borne sound signals propagating in and on the tank may be captured for various known fill statuses and stored as reference values. The reference values may thus be structure-borne sound signal patterns that can be stored in a data memory for example. The reference values may be retrieved from the data memory for comparison. In order to record the reference values, a completely empty tank may be filled with known filling quantities, for example, to record the corresponding reference values. The characteristic structure-borne sound signal patterns may then be captured and compared with the reference values when the vehicle is in operation, that is to say as the fluid is being removed from the tank, to enable a conclusion to be drawn about the current filling statuses.

In a further development of the method, the tank is equipped with least one signal emitter, wherein the at least one signal emitter is designed to emit and/or to influence structure-borne sound signals propagating in and on the tank, wherein at least one structure-borne sound signal influenced and/or generated by the signal emitter is captured by means of the sensor assembly, and wherein the structure-borne sound signal captured by means of the sensor assembly is evaluated to determine the fluid fill level in the tank. At least one signal emitter is embedded in at least one wall of the tank. A signal emitter may be for example a fibre, such as for example a carbon fibre, a glass fibre, a glass bead, a plastic bead, or also an acoustic fibre or a fibre composite. Preferably, a multiplicity of signal emitters are embedded in even distribution in the wall of the tank. For example, the signal emitters may be laminated into the material of the outer casing, that is to say into the fibre-reinforced composite material of the outer casing, for example. In such a case, the properties of the signal emitter fibres may be chosen such that they react to loads on the housing structure before the fibres that make up the housing structure. For example, the signal emitter fibres may react more sensitively to expansion loads or bending loads, such as the stretching of the tank when refuelling, than the fibres that constitute the housing structure, and in so doing emit characteristic structure-borne sound signal patterns. In this way, early detection of the structure-borne sound signal patterns is achieved. Structure-borne sound signals propagating in and on the tank can also be influenced, in particular amplified, by the acoustic signal emitters. For example, the structure of the tank, in particular the structure of its, can be influenced by the signal emitters, in turn causing a change in the propagating structure-borne sound signal. This yields an improved signal-to-noise ratio, thereby enabling reliable detection of characteristic structure-borne sound signal patterns. Structure-borne sound signals propagating in and on the tank may also be generated by the signal emitters, with the result that they can be detected more easily. This can happen for example due to the changes in the filling status when the tank expands or contracts. For example, various cracking sounds or other structure-borne sound signal patterns may be produced by the signal emitters when different filling statuses occur, which can easily be detected and associated with the different fill statuses.

In a further development of the method, at least one signal emitter is embedded in at least one wall of the of the tank. By embedding the acoustic signal emitters, such as fibres made of various materials or also beads, these can be provided at the very start, in the manufacturing process of the tank. Embedding them in the wall material makes it possible to capture the structure-borne sound signals propagating in and on the tank exactly.

In a preferred further development of the method, the signal emitters are fibres, and the fibres are made from at least a similar, in particular the same material as the fibres from which the housing structure is manufactured. The housing structure may consist of a fibre-reinforced plastic, in particular carbon fibre-reinforced composite material of glass fibre-reinforced plastic, or also of another material. The signal emitters are preferably fibres of the kind from which the housing structure is constructed. Accordingly, for a housing structure of glass fibre-reinforced plastic the signal emitters may consist of glass fibres, and for a housing structure of carbon fibre-reinforced plastic the signal emitters may consist of carbon fibres. When the same material is selected for the signal emitter fibres and the structure-forming fibres, the fibre structure of the housing structure is not disrupted. No defect sites are created in the housing structure by the signal emitter fibres, so the stability of the housing structure is preserved. The signal emitter fibres preferably have slightly different material properties from the fibres that make up the housing structure. In particular, the material properties may be chosen such that the signal emitter fibres emit structure-borne sound signals before the other structure-forming fibres for various statuses of the housing structure. For example, the signal emitter fibres may indicate signs of damage such as breakage of the fibre under load before the structure fibres. These signs of damage can be detected early by via the structure-borne sound sensor system.

In a preferred further development of the method, the fibres that form the signal emitters have a lower tensile strength and/or a higher tensile E-Modul and/or a lower strain at failure. The tensile strength is understood to mean the maximum force in the direction of the fibre that the material is able to withstand under load before it breaks. If the signal emitter fibres have a lower tensile strength than that of the structure-forming fibres, it can be assumed that the signal emitter fibres will break or be damaged before the structure-forming fibres when a load is applied to the housing structure. Thus, the signal emitter fibres also emit a detectable structure-borne sound signal pattern before the other fibres. This can be detected early by means of the structure-borne sound sensor system and associated with a fluid fill level. The strain at failure describes the maximum proportional change in length of the material before it tears or breaks. The strain at failure is a measure of the ductility of the material. A lower strain at failure of the signal emitter fibres also enables early emission of a structure-borne sound signal. The modulus of elasticity describes the rigidity of a material, that is to say the ratio of load and expansion in the elastic range.

In a further development of the method, characteristic structure-borne sound signal patterns are emitted by the signal emitters for different fluid fill levels and a conclusion is drawn about the fluid fill level in the tank when upon detection of a characteristic structure-borne sound signal pattern. By emitting characteristic structure-borne sound signal patterns, such as various cracking sounds or the like, different fluid fill levels in the tank can be determined easily. For example, the characteristic structure-borne sound signal patterns can be produced by the signal emitter fibres during expansion and contraction of the tank.

In a further development of the method, the characteristic structure-borne sound signal patterns influenced and/or produced by the signal emitters are filtered out of a background noise. Characteristic structure-borne sound signal patterns are produced by the signal emitters, or the structure-borne sound signals propagating in and on the tank are influenced correspondingly by the acoustic signal emitters. An influence on the propagating structure-borne sound signals may be induced for example by a structural change in the wall of the tank by the signal emitters. This allows a simple distinction to be made between the characteristic structure-borne sound signal patterns and a permanently present background noise. The structure-borne sound signal patterns are preferably produced by signal emitter fibres, when the fibres are stretched or bent, for example. The background noise may be produced for example by the driving operation of a motor vehicle in which the tank has been installed. The structure-borne sound signals influenced or produced by the signal emitters may be filtered out easily by the characteristic signal patterns.

In a further development of the method, the signal emitters may be glass fibres and/or carbon fibres and/or glass beads and/or plastic beads and/or acoustic fibres, made for example from a composite material or also carbon fibres or similar. These signal emitters may be embedded in the wall of a tank quite easily.

In a further development of the method, the sensor assembly includes at least a central control unit and at least one transmitter unit, wherein the central control unit and the at least one transmitter unit are designed to produce and receive structure-borne sound signal patterns, wherein at least one structure-borne sound signal pattern is transmitted by means of the transmitter unit, wherein the structure-borne sound signal pattern transmitted by the transmitter unit is received and evaluated by means of the central control unit, and wherein a conclusion is drawn about the fluid fill level in the tank from the received structure-borne sound signal pattern. A sensor assembly with a central control unit and multiple transmitter units may be used in the method. The central control unit and the transmitter units are designed to produce and receive structure-borne sound signal patterns. In this context, structure-borne sound signal patterns that propagate in and on the tank that is to be monitored can be captured. Structure-borne sound signal patterns generated by the central control unit and the transmitter units can also be monitored and evaluated actively. Structure-borne sound signal patterns are generated via a piezoelectric element for example, by means of at least one transmitter unit, preferably by means of multiple transmitter units. The structure-borne sound signal pattern transmitted by the transmitter unit is received by the central control unit and evaluated by an evaluation device. A conclusion may be drawn about the fluid fill status of the tank from the occurrence of characteristic signal patterns, characteristic frequencies, characteristic signal profiles or similar. The characteristic signal patterns may be produced and/or influenced by the signal emitters. Influence on the propagating structure-borne sound signals may be induced by the signal emitters by a structural change in the housing structure for example. Control commands may also be generated by the central control unit and sent to the transmitter units in the form of structure-borne sound signal patterns. Digital or analogue encoded control commands may be sent by the central control unit to the transmitter units in the form of structure-borne sound signal patterns, for example by wavelets, standing waves, chirps or the like. In this way, for example, the transmitter units may be actuated to generate certain structure-borne sound signal patterns or the like. Signal transmission between the central control unit and the transmitter units via structure-borne sound signals means that no extra data lines or the like need to be installed, and the sensor assembly can be arranged in the tank inexpensively.

A further aspect of the invention relates to a tank for holding fluids, wherein the tank is connected to at least one sensor assembly in a manner conductive of structure-borne sound signals, wherein the sensor assembly includes at least one structure-borne sound sensor for capturing structure-borne sound signals propagating in and/or on the tank, wherein the sensor assembly is connected to at least one evaluation device in a manner that allows transfer of signals, wherein the tank has at least one signal emitter, wherein the at least one signal emitter is designed to emit and/or influence structure-borne sound signals propagating in and on the tank. The tank may be in particular a hydrogen tank of a motor vehicle, with an outer casing and an inner casing. In such a case, the outer casing of the tank may be manufactured from a fibre-reinforced composite material. In order to enable the capture of structure-borne sound signals propagating in and on the tank, in particular of vibrations when the tank is being filled or emptied, the tank is connected to at least one structure-borne sound sensor of a sensor assembly in a manner conductive of structure-borne sound signals. The sensor assembly preferably includes multiple structure-borne sound sensors. The structure-borne sound sensor may include a piezoelectric element for example for capturing the vibrations. The vibrations that occur are characteristic for the respective fluid fill level of the tank, and/or the vibrations propagating in and on the tank may vary with the fluid fill level. The vibrations propagating in and on the tank in each case may thus be associated with a fluid fill level. For the evaluation of the structure-borne sound signals, the sensor assembly has a connection that allows data to be transmitted to an evaluation device. The evaluation device may be for example a computing unit, the onboard computer or similar. Signal emitters may be for example fibres, such as for example glass fibres or carbon fibres, glass beads, plastic beads, or also acoustic fibres, or fibre composites. In such a case, the signal emitter function in particular as acoustic signal emitters. The structure-borne sound signals propagating in and on the tank may be influenced, in particular amplified by the acoustic signal emitters. In this way, an improved signal-to-noise ratio is assured, enabling a reliable detection of characteristic structure-borne sound signal patterns. Influencing of the propagating structure-borne sound signals may be induced for example by a change in structure of the housing structure via the signal emitters. The structure-borne sound signals propagating in and on the tank may preferably be produced by the signal emitters, in particular by the stretching and bending of signal emitter fibres, so that they can be detected more easily and sooner. This may take place for example when the tank expands or contracts due to changes in its filling status. For example, various cracking sounds or the like may be produced by the signal emitters for different filling statuses, and these may be detected easily by means of structure-borne sound sensor system and associated with the various fill statuses.

In a further development of the invention, at least one signal emitter is embedded in at least one wall of the tank. Preferably, a multiplicity of signal emitters are embedded, evenly distributed, in the wall of the tank. For example, the signal emitter may be laminated into the material of the outer casing, that is to say laminated into the fibre-reinforced composite material of the outer casing for example.

In a further development of the invention, the signal emitters are glass fibres and/or carbon fibres and/or glass beads and/or plastic beads and/or acoustic fibres. These signal emitters may easily be embedded in the wall of a tank.

In a preferred further development of the invention, the signal emitters are fibres, and the fibres consist of an at least similar, in particular the same material as the fibres from which the housing structure was manufactured. The housing structure may consist of a fibre-reinforced plastic, in particular a carbon fibre-reinforced composite material or glass fibre-reinforced plastic, or also another material. The signal emitters are preferably fibres of the kind from which the housing structure was constructed. Accordingly, with a housing structure made from glass fibre-reinforced plastic the signal emitters may be made of glass fibres, and with a housing structure made from carbon fibre-reinforced plastic the signal emitters may be made of carbon fibres. When the same material is selected for the signal emitter fibres and the structure-forming fibres, the fibre structure of the housing structure is not disrupted. No defect sites are created in the housing structure by the signal emitter fibres. The signal emitter fibres preferably have slightly different material properties from the fibres that make up the housing structure. In particular, the material properties may be chosen such that the signal emitter fibres emit structure-borne sound signals before the structure-forming fibres, which signals may be detected early by via the structure-borne sound sensor system

In a preferred further development of the method, the fibres that form the signal emitters have a lower tensile strength and/or a higher tensile E-Modul and/or a lower strain at failure. The tensile strength is understood to mean the maximum force in the direction of the fibre that the material is able to withstand under load before it breaks. If the signal emitter fibres have a lower tensile strength than that of the structure-forming fibres, it can be assumed that the signal emitter fibres will break or be damaged before the structure-forming fibres when a load is applied to the housing structure. Thus, the signal emitter fibres also emit a detectable structure-borne sound signal pattern before the structure-forming fibres. This can be detected early by means of the structure-borne sound sensor system and associated with a fluid fill level. The strain at failure describes the maximum proportional change in length of the material before it tears or breaks under tensile load. The strain at failure is a measure of the ductility of the material. A lower strain at failure of the signal emitter fibres also enables early emission of a structure-borne sound signal. The tensile E-Modul describes the rigidity of a material, that is to say the ratio of load and expansion in the elastic range

In a further development of the invention, the fibres that form the signal emitters are arranged in bulges in the housing structure. In particular, a tank for holding fluids may have bulges towards the ends thereof, for example. If the signal emitter fibres are arranged in the bulging regions, the susceptibility of the fibres to bending loads can be exploited to enable early detection of critical statuses of the housing structure. In particular, the signal emitter fibres may be arranged along the bend.

In a further development of the invention, the sensor assembly includes at least a central control unit and at least one transmitter unit, wherein the central control unit and the at least one transmitter unit are designed to generate and receive structure-borne sound signal patterns. The central control unit and the transmitter units are designed to generate and receive structure-borne sound signal patterns. In this context, structure-borne sound signal patterns that propagate in the tank that is to be monitored can be captured. Structure-borne sound signal patterns generated by the central control unit and the transmitter units can also be monitored and evaluated actively. Structure-borne sound signal patterns are generated via a piezoelectric element for example, by means of at least one transmitter unit, preferably by means of multiple transmitter units. The structure-borne sound signal pattern transmitted by the transmitter unit is received by the central control unit and evaluated by an evaluation device. A conclusion may be drawn about the fluid fill status of the tank from the occurrence of characteristic signal patterns, characteristic frequencies, characteristic signal profiles or the like. The characteristic signal patterns may be produced and/or influenced by the signal emitters. Influence on the propagating structure-borne sound signals may be induced by the signal emitters by a structural change in the housing structure for example. The structure-borne sound signal patterns are preferably produced by bending and stretching the signal emitter fibres. Control commands may also be generated by the central control unit and sent to the transmitter units in the form of structure-borne sound signal patterns. Digital or analogue encoded control commands may be sent by the central control unit to the transmitter units in the form of structure-borne sound signal patterns, for example by wavelets, standing waves, chirps or the like. In this way, for example, the transmitter units may be actuated to generate certain structure-borne sound signal patterns or the like. Signal transmission between the central control unit and the transmitter units via structure-borne sound signals means that no extra data lines or the like need to be installed, and the sensor assembly can be arranged in the tank inexpensively.

A further aspect relates to a motor vehicle with a tank according to the invention. A tank as described may be advantageous in particular when used in a motor vehicle powered with hydrogen.

### BRIEF DESCRIPTION OF THE DRAWINGS

In the following text, the invention will be explained in greater detail with reference to an embodiment represented in the drawing. In detail, the schematic illustration shows in:

The sole FIGURE illustrates a tank according to the invention, with acoustic signal emitters and a sensor assembly;

### DETAILED DESCRIPTION

The figure represents a tank 1 with a wall 2, a sensor assembly 3 and acoustic signal emitters 4-6. The wall 2 of the tank 1 consists of a fibre composite material, such as for example glass fibre-reinforced plastic or carbon fibre-reinforced plastics. A possible inner casing is not represented. The tank 1 is provided for holding a fluid medium 7, in particular a gas-phase or liquid medium. The sensor assembly 3 is formed by the central control unit 8 and a transmitter unit 9. The central control unit 8 and the transmitter unit 9 each include at least one piezoelectric element for capturing the vibrations propagating in and on the wall 2. The central control unit 8 may be designed to send out structure-borne sound signals, with which the transmitter unit 9 can be actuated. Here, it is represented schematically that a signal emitter 4 may be a fibre composite, an acoustic signal emitter 5 may be a sphere, made for example of plastic or glass, and an acoustic signal emitter 6 may be a single fibre. When the fluid volume contained in the tank changes, the wall 2 expands or contracts, represented here by the arrows 10. For example, when a gas is held in the tank 1, the wall 2 may be expanded, with the result that structure-borne sound signals are generated on the wall 2. In this process, characteristic structure-borne sound signal patterns are generated by the acoustic signal emitters 4-6 and are captured by the sensor assembly 3. A conclusion about the respective fluid fill level in the tank may be drawn from the characteristic structure-borne sound signal patterns.

1. A method for determining the fluid fill level in a tank for holding fluids, wherein the tank is connected to at least one sensor assembly in a manner conductive of structure-borne sound signals, wherein the sensor assembly includes at least one structure-borne sound sensor for capturing structure-borne sound signals propagating in and on the tank,
wherein structure-borne sound signals propagating in and on the tank (Hare detected via the structure-borne sound sensor, and
wherein a conclusion is drawn about the fluid fill level in the tank on the basis of the captured structure-borne sound signals.

2. The method according to claim 1, wherein at least one structure-borne sound signal propagating in and on the tank is captured for at least one known fluid fill level and stored as reference value.

3. The method according to claim 1, wherein the tank includes at least one signal emitter, wherein the at least one signal emitter is designed to emit and/or to influence structure-borne sound signals propagating in and on the tank, wherein at least one structure-borne sound signal influenced and/or produced by the signal emitter is captured by means of the sensor assembly, and wherein the structure-borne sound signal captured by means of the sensor assembly is evaluated to determine the fluid fill level in the tank.

4. The method according to claim 3, wherein the at least one signal emitter is embedded in at least one wall of the tank.

5. The method according to claim 3, wherein the signal emitters are fibres and that the fibres are made from an at least similar, in particular from the same material as fibres from which the housing structure has been manufactured.

6. The method according to claim 5, wherein the fibres that form the signal emitters have a lower tensile strength and/or a higher tensile E-Modul and/or a lower strain at failure than the fibres from which the housing structure is constructed.

7. The method according to claim 3, wherein characteristic structure-borne sound signal patterns are emitted by the signal emitters at various fluid fill levels in the tank, and that a conclusion is drawn about the fluid fill level in the tank when a characteristic structure-borne sound signal pattern is captured.

8. The method according to claim 3, wherein the characteristic structure-borne sound signal patterns influenced and/or produced by the signal emitters are filtered out of a background noise.

9. The method according to claim 3, wherein the signal emitters are glass fibres and/or carbon fibres and/or glass beads and/or plastic beads and/or acoustic fibres.

10. The method according to claim 1, wherein the sensor assembly includes at least a central control unit and at least one transmitter unit, wherein the central control unit and the at least one transmitter unit are designed to generate and to receive structure-borne sound signal patterns, wherein at least one structure-borne sound signal pattern is transmitted by means of the transmitter unit, wherein the structure-borne sound signal pattern transmitted by the transmitter unit is received and evaluated by the central control unit, and wherein a conclusion is drawn about the fluid fill level in the tank on the basis of the received structure-borne sound signal pattern.

11. A tank for holding fluids, wherein the tank is connected to at least one sensor assembly in a manner conductive of structure-borne sound signals, wherein the sensor assembly includes at least one structure-borne sound sensor for capturing structure-borne sound signals propagating in and/or on the tank, wherein the sensor assembly is connected to at least one evaluation device in a manner that allows data to be transmitted, wherein the tank includes at least one signal emitter, wherein the at least one signal emitter is designed to emit and/or influence structure-borne sound signals propagating in and/or on the tank.

12. The tank according to claim 11, wherein the at least one signal emitter is embedded in at least one wall of the tank.

13. The tank according to claim 1, wherein the signal emitters are fibres, and that the fibres are made from an at least similar, in particular from the same material as fibres from which the housing structure has been manufactured.

14. The tank according to claim 11, wherein the fibres that form the signal emitters have a lower tensile strength and/or a higher tensile E-Modul and/or a lower strain at failure than the fibres that form the housing structure.

15. The tank according to claim 11, wherein the signal emitters are glass fibres and/or carbon fibres and/or glass beads and/or plastic beads and/or acoustic fibres.

16. The tank according to claim 11, wherein the fibres the form the signal emitters are arranged in bulges in the housing structure.

17. The tank according to claim 11, wherein the sensor assembly includes at least a central control unit and at least one transmitter unit, wherein the central control unit and the at least one transmitter unit are designed for generating and for receiving structure-borne sound signal patterns.

18. A motor vehicle having the tank according to claim 11.
